(19) United States
(12) Patent Application Publication
(10) Pub. No.: US 2016/0018910 A1
(43) Pub. Date: Jan. 21, 2016

(54) METHOD FOR ASSOCIATING A PEN SHAPED HAND HELD INSTRUMENT WITH A SUBSTRATE AND/OR FOR DETECTING A SWITCHING OF THE SUBSTRATE AND PEN SHAPED HANDHELD INSTRUMENT

(71) Applicant: Christian Walloth, Grafschaft (DE)

(72) Inventor: Christian Walloth, Grafschaft (DE)

(21) Appl. No.: 14/792,150

(22) Filed: Jul. 6, 2015

Related U.S. Application Data
(63) Continuation of application No. PCT/EP2014/050090, filed on Jan. 6, 2014.

(30) Foreign Application Priority Data
Jan. 7, 2013 (DE) DE102013200080.4

(51) Int. Cl. G06F 3/038; G06F 3/0354

(52) U.S. Cl. CPC G06F 3/0386; G06F 3/03542

(57) ABSTRACT

The invention relates to a method for associating a pen shaped hand held instrument with a substrate and/or for detecting a switching of the substrate, wherein the hand held instrument, includes at least one pen tip which generates a marking, a shaft, and at least one optical sensor which detects at least a coarse pattern from an identification position in which the pen tip has a distance from the substrate, wherein the at least one optical sensor detects at least the coarse pattern at least in an identification area which includes a portion of the substrate and at least a lateral edge of the substrate and/or at least a portion of a surrounding area of the substrate which surrounding area is directly adjacent to all edges of the substrate. The invention also relates to a pen shaped hand held instrument including at least one pen tip.

### RELATED APPLICATIONS

This application is a continuation of International Patent Application PCT/EP2014/050090 filed on Jan. 6, 2014 claiming priority from German Patent application DE 10 2013 200 080.4, filed on Jan. 7, 2013, both of which are incorporated in their entirety by this reference.

### FIELD OF THE INVENTION

The invention relates to a for method associating a pen shaped hand held instrument with a substrate and/or for detecting a change of the substrate, wherein the hand held instrument includes at least a pen tip generating a marking and a shaft and at least one optical sensor.

The invention furthermore relates to a hand held instrument for processing a substrate, in particular a sheet of paper, including at least one pen tip; a shaft, wherein the pen tip in an operating position of the hand held instrument is in contact with the substrate; and at least one optical sensor, wherein the at least one optical sensor is arranged proximal to the pen tip at an end of the hand held instrument that is oriented towards the substrate, and wherein the optical sensor has the image angle of at least 90°, advantageously at least, further advantageously at least, wherein at least an identification area which includes a portion of the substrate and at least a lateral edge of the substrate and/or at least a portion of a surrounding area of the substrate which is directly adjacent to all edges of the substrate is detectable from an identification position in which the pen tip has a distance from the substrate.

The hand held instruments described herein and the method according to the invention relate in particular to writing instruments which are typically designated as “smart pens” in the market and which are used in particular for capturing and stonng manually produced notes on a computer.

Typically a sheet of paper is used as a substrate on which a marking is generated by the hand held instrument, this means on which writing and/or drafting shall be preformed. However, it is also conceivable to consider a so called “white board” or any other suitable surface as a “substrate” according to the present invention irrespective of dimensions of the substrate.

The term “marking” according to the instant invention relates to a written marking generated by a writing tip and also to a cut marking generated by a cutting tip as well as other types of markings that can be generated by a hand held instrument. The instant invention in addition to the recited writing pens also relates to hand held cutting instruments that are typically used for modeling and for cutting out textile or paper materials

### BACKGROUND OF THE INVENTION

A hand held instrument of the type described supra configured as a writing instrument can be derived from DE 196 44 109 A4. This application describes a data processing system which facilitates storing a movement of a writing instrument. Thus, the writing instrument includes a detection system which detects a movement of the writing instrument in space and subsequently processes it in a computing unit. The data generated therefrom can be stored thereafter and thus be reproduced at will. For a detection system DE 196 44 109 A4 proposes for example acceleration sensors which detect a movement of the writing instrument in space.

Furthermore using an optical sensor is disclosed which is used for identifying a bar code (“binary code”) on a page of a document. This way the illustrated writing instrument facilitates for a user to write on different substrates which is detected by a data processing system and processed accordingly. In order to do so a user has to capture a respectively associated bar code with the optical sensor every time the substrate changes so that the information regarding the substrate change is provided to the data processing system.

This method in particular has the disadvantage that a user is not free to change the substrate, but always needs a special substrate which is encoded accordingly and thus adapted to the data processing system. This causes the user of the writing instrument to be dependent on special paper and thus his choices being limited and on the other hand side the user has to keep the paper in stock all the time.

US 2002/0163511 A1 discloses a pen shaped hand held instrument which captures feature points on a substrate and/or in its environment using at least one optical sensor. The described hand held instrument is configured to determine a position of a pen tip relative to a substrate while the hand held instrument is in an operating position. The indicated problem of associating different substrates and/or detecting a switch between substrates, however, is not discussed in this document. A similar instrument and method for detecting the position of the pen tip relative to featured points is also known from U.S. Pat. No. 7,203,384 and U.S. Pat. No. 7,474,809.

Another writing instrument of the type described supra can also be derived from EP 0507269B1. This document discloses a writing instrument which facilitates capturing and storing hand notes. The problem of detecting different substrates is not discussed in this document either.

The same applies for the writing instrument known from EP 0 669 594 A2 which detects a marking generated by the writing instrument in an operating position using an optical sensor. Another document, DE 692 04 336 T2 describes a writing instrument which performs an optical detection of notes that have been made. The third paragraph of this document on page 4 describes that an optical sensor is used on one side to detect respective notes while the writing instrument is in a writing position and the optical sensor is also used to detect the location of the writing instrument when the writing instrument is lifted from the substrate, thus for example during a switch from one written word to another. Thus, overall the optical sensor is used to continuously detect a location of the writing instrument relative to the surface provided irrespective of how the writing instrument is used for the time being.

DE 601 19 393 T2 describes a writing instrument which includes an optical sensor which detects macroscopic elements of the writing substrate. Suitable navigation software is configured to detect a movement of the writing instrument relative to the writing substrate.

A pen is known from GB 2 439 754 A which is configured in a portion of its tip with an optical sensor for detecting a document ID that is applied to a writing substrate and written data. In order to active a data memory it is required that a document ID printed on the writing substrate which is detected by the optical sensor coincides with the document ID previously stored on the storage medium.

EP 1154377A1 discloses a pen shaped device which includes a camera which captures information in an operating position of the hand held instrument, wherein the information is directly adjacent to the tip of the pen. A device of this type is not configured to detect an area of the work surface and/or its environment which is big enough to associate the hand held instrument with changing substrates from an identification position.

U.S. Pat. No. 5,774,602 discloses a pen shaped hand held instrument which can include an optical sensor so that the hand held instrument can be used as a camera. According to the invention the hand held instrument is configured to capture images of the contents of the hand held instrument from a position that is remote from the substrate. However, a manual alignment of the hand held instrument relative to the work surface is provided, so that the hand held instrument is not configured to detect a change of a page from a natural hand movement of the user.

A similar device is also known from U.S. Pat. No. 6,603,464 which proposes a writing instrument which is configured on one side to capture images of an immediate environment of the pen tip and which is configured to also capture images like with a camera. An association of the hand held instrument with a substrate can be preformed when the substrate is a form which is known to a connected data processing system.

Known art for associating a writing instrument with a substrate is also described in technical literature. Thus it is summarized in section 2.12 and section 2.14 of Steimle (2012) that according to the known art either special markings of the writing substrate are required or movements of pen and substrate on a work surface are detected and processed wherein the movements are caused by a user and captured by cameras arranged in a room. An embodiment of this type of technology is described in Kim et al. (2004). A registration of changing a substrate that is in particular not known to a data processing system without external assistance is not discussed.

A mobile telephone is discussed in EP 1 255 185 A1, whose antenna can be used as a pen after a cap has been removed. The pen shall be used in particular when the user shall identify himself with a signature or by entering a code. For this purpose a camera is provided in an upper portion of the mobile phone.

A method is known from U.S. Pat. No. 5,900,943 A which differentiates different substrates based on their different colors. The colors of the substrates can be detected by an optical sensor in a writing hand held instrument that is used for processing the substrates. The method is based on the one hand side on detecting the color of the substrate on the other hand side on comparing the detected color with colors stored in a data processing system that is connected which facilitates a unique association of a substrate. Thus, this method is configured to detect a switch between a preselected set of substrates with different colors, e.g. forms using a hand held instrument which detects a color of a substrate. Furthermore it is possible for the system to learn new colors so that it can also differentiate unknown substrates which, however, have to have different colors.

### BRIEF SUMMARY OF THE INVENTION

It is an object of the present invention to propose a method and a pen shaped hand held instrument so that the pen shaped hand held instrument can be associated with a substrate and/or a change of the substrate can be detected without the user of the hand held instrument having to resort to a specially prepared substrate (e.g. a specially encoded paper) or other aids besides the hand held instrument.

The technical object is achieved according to the invention by a method for associating a pen shaped hand held instrument with a substrate and/or for detecting a change of a substrate, wherein the hand held instrument has at least one pen tip generating a marking and a shaft and at least one optical sensor which is configured to detect at least a coarse pattern from an identification position in which the pen tip has a distance from the substrate wherein the detection is performed in an identification area which in addition to a portion of the substrate includes at least one lateral edge of the substrate and/or at least a portion of a surrounding area of the substrate which is directly adjacent to all edges of the substrate.

Thus the invention is based on the idea that a unique association of hand held instrument with a substrate and/or a detection of a change of the substrate can be facilitated in that a sufficiently large portion of the substrate is optically detected, wherein a “coarse pattern recognition” is performed by the at least one optical sensor. This means that it is not required that the portion of the substrate is detected with full resolution; the detected image may rather be slightly unfocussed. Thus, it is sufficient when a coarse pattern is detected. Thus, it can be helpful when the optical sensor has a high level of depth resolution.

For example the portion that is detected by the optical sensor shall be depicted with sufficient focus at a distant of 3 cm as well as a distance of 10 cm. Alternatively, however, it is also conceivable that the optical sensor has auto focus so that the detected image is depicted in focus also at different distances.

In particular it is helpful when the detected portion is configured so that at least a lateral edge of the substrate, advantageously two opposite edges of the substrate are detected by the at least one optical sensor. Due to the collected optical information of the at least one optical sensor (written characters on the substrate, objects adjacent to the substrate, edges of the substrate etc.) the hand held instrument can be unambiguously associated with a particular substrate, and/or a change of the substrate can be detected. Thus, the captured data is configured to determine on which substrate the hand held instrument is currently used. Furthermore it is configured by the described “edge observation” to determine at which location on the substrate the hand held instrument is currently located. For this purpose it is necessary to examine a certain minimum area of the substrate and optionally of the surrounding area in order to facilitate a unique association, this means to collect a certain minimum amount of information. The image angle of the at least one optical sensor described infra is used to detect a large portion of the substrate and optionally of a surrounding portion outside of the substrate itself when the hand held instrument is arranged rather close to the substrate. In one embodiment of the hand held instrument it can be advantageous for reducing the requirements with respect to depth focus when the optical sensor is not arranged perpendicular to the pen axis, but at an angle which for example compensates the inclination of the pen during writing or when changing the substrate so that the optical sensor and the substrate in this situation are arranged as much in parallel to each other as possible. Also an automatic tilt approximation for example using piezo electric actuators is conceivable.

Thus, it is possible using the hand held instrument according to the invention to continuously change the substrate that is processed respectively, wherein the hand held instrument continuously identifies on which substrate it is being used and how the substrates are being positioned relative to each other. Information with this respect can be considered accordingly so that a correct reproduction of generated markings can be performed in a digital form thereafter. Using a special substrate like in the known art is not necessary anymore.

Furthermore it is not necessary to bring the hand held instrument into a dedicated “identification position” for each substrate change wherein the identification position has a minimum distance from the new substrate which minimum distance is not already reached during a natural movement of the hand held instrument. It rather suffices already to move the hand held instrument in a normal manner, this means to lift it in a normal manner from the current surface and to move it over the new surface to be processed without having to “actively” consider identification of the new substrate. A special adaption of a behavior of the user of the hand held instrument is therefore not required.

It is particularly advantageous when the at least one optical sensor has an image angle of at least 90°, advantageously 100°, further advantageously 110°.

The “image angle” according to the instant application is defined between idealized light beams which extend from opposite edges of an image surface of the optical sensor to a center of a refraction plane of the optical sensor. For a rectangular image surface of the optical sensor therefore there are two image angles, a vertical image angle and a horizontal image angle are provided. The image angle according to the instant application is always the larger one of the two image angles. In a square image surface of the optical sensor the horizontal and vertical image angle are identical.

Besides the vertical and horizontal image angle typically the so called “diagonal” image angle is described which extends between the idealized light beams which extend from opposite corners of the image surface of the optical sensor to a center point of the refraction plane of the optics. This diagonal image angle is not referenced in claim 1, but as discussed always the vertical or the horizontal image angle are referred, depending which of the two is larger.

So called “moderate wide angle lenses” have for example a diagonal image angle in a range of 60° to 75°. Tele focus lenses, however, have an image angle of less than 20°. An optical sensor with a described image angle of at least 90° is particularly well suited to capture a large surface of the substrate and a surrounding area of the substrate from a comparatively short distance from the hand held instrument to the substrate.

Capturing an image angle using at least one optical sensor is interpreted as the described image angle being covered by at least one optical sensor, thus optionally by plural optical sensors. Thus, it is conceivable that the recited image angle is jointly covered by two optical sensors, wherein each optical sensor covers at least a partial image angle of 45°, wherein partial detection portions of both sensors are directly adjacent to each other or overlap each other. Using three of more optical sensors is also conceivable. Typically in an arrangement including multiple optical sensors a certain overlap portion of the partial detection portion of the individual optical sensors will be provided so that for example individual partial image angles of two optical sensors with a size of 55° respectively jointly provide an image angle of 100° wherein an overlap of the two partial detection portions of the two optical sensors is provided which reduces the partial image angle which is covered exclusively by one optical sensor to 50°. A graphic description of these facts can be derived from an embodiment described infra.

According to the preceding description it can be particularly advantageous when two optical sensors jointly form the image angle of at least 90°, advantageously at least 100°, further advantageously at least 110°, wherein each sensor advantageously covers a partial detection area. For example the hand held instrument could include one respective optical sensor on opposite sides of the shaft wherein the optical sensor detects a partial image angle so that both optical sensors jointly detect the total image angle. This could be advantageous in that a detection area of opposite optical sensors respectively could cover one “side” of the hand held instrument and an impairment of the imaging for example by a hand of the user of the hand held instrument can be avoided.

A detection area that is too small for example could have the consequence that the one optical sensor only captures a white surface on a first substrate and also on a second substrate though different notes are written down on both substrates outside of the white surfaces. This information consequently could not be detected and therefore not considered. A software that subsequently processes the data therefore would not be able to make an association from the information “white surface”. With a greatly enlarged detection area that is provided for the at least one optical sensor, however, a mix up of this type is precluded since the detected information considers the substrate in a large portion advantageously in its entirety so that differences between individual substrates can be registered. Furthermore an observation of a surrounding area of the substrate is facilitated which observation occurs the more, the greater the detection area of the hand held instrument. The surrounding area can facilitate an association with a particular substrate substantially in that the detection is not only based on markings already left on the substrate, for example written lines, but that can be furthermore based on objects that are located in the surrounding area of the hand held instrument, for example a protractor or a glass. The surrounding area is directly adjacent to all edges of the substrate and is therefore arranged around the substrate. It is advantageous for identifying a substrate that is so far not covered with writing when as much as possible of the surrounding area is detected.

In an advantageous embodiment of the hand held instrument according to the invention the detection area covers a surface of at least 50 cm², advantageous at least 100 cm², further more advantageously at least 200 cm² of the substrate or of a surrounding area of the substrate. The additional size of the detection area facilitates increased detection performance.

The technical object is furthermore achieved by a hand held instrument of the type recited supra with the characterizing features of claim 7. Thus, the hand held instrument has at least three acceleration sensors that are respectively arranged perpendicular to each other which facilitate continuously detecting accelerations of at least a portion of the hand held instrument, advantageously of the pen tip in a three dimensional space, wherein the acceleration sensors are advantageously supplyable with electrical energy from an energy storage device that is advantageously arranged at the hand held instrument. Using the acceleration sensors it is particularly facilitated to detect a movement of the pen tip and to digitize and store the marking drawn or generated by the pen tip.

Furthermore it is facilitated by the acceleration sensors to differentiate movement types of the hand held instrument from each other. Thus, the acceleration values of the hand held instrument during an operating movement typically differ from a movement of the hand held instrument in space, for example when the hand held instrument is handed to another user. A respective analysis of the captured data with respect to such differences can be used for example for activating an identification function since a particular type of movement of the hand held instrument indicates that the respectively processed substrate is being changed. Furthermore the hand held instrument can detect with the acceleration sensors when it is being picked up by a user, for example from a drawer. This information could be processed so that the hand held instrument switches directly into an identification mode and adapts itself to detecting an identification portion of a substrate. It is also conceivable that the acceleration sensors detect a “touch-down” of the pen tip on the substrate. A touch-down of this type comes with a high negative acceleration whose amount differs significantly from the usual acceleration spectrum. Furthermore it is possible with the acceleration sensors to detect speed and inclination of the hand held instrument and to use this information on the software side to differentiate different line thicknesses or different users.

In another advantageous embodiment of the hand held instrument according to the invention the hand held instrument includes at least one optical sensor which is advantageously arranged at the pen tip and which is activated at least in the operating position of the hand held instrument and which detects a monitoring area of the substrates which is advantageously arranged on one side of the pen tip which is oriented away from a movement direction of the pen tip in its operating position. An optical sensor of this type is well suitable to detect the marking generated by the hand held instrument. Thus the optical sensor is suitable for “fine pattern recognition”.

Thus, an optical sensor of this type can be an alternative to the recited acceleration sensors since the optical sensor is used for detecting the marking generated by the pen tip and renders the acceleration sensors superfluous at least for these purposes. For an optical sensor of this type the described monitoring area which is typically rather small compared to the detection area for coarse pattern detection is particularly advantageous depending on the application since the optical sensor can detect the monitored area in rather fine detail and is therefore quite well suited for detecting the notes that have been recorded. Furthermore the focal length of this optical sensor is smaller than the focal length of the first recited optical sensor for identifying the substrate that has to be processed respectively since a distance from the substrate of the second sensor is significantly reduced compared to the first sensor in the operating position of the hand held instrument.

It is also easily conceivable that both detection options for detecting the generated marking, namely a “second” optical sensor according to the preceding description and acceleration sensors are combined with each other in order to generate redundancy which facilitates a high detection rate of the generated marking so that a quality of the recorded notes can be improved.

As a matter of principle the optical sensor that is being used for detecting the drawn marking can also be formed by a separate (additional) optical sensor or by the same optical sensor that is being used for performing coarse pattern recognition for identifying the respective substrate. Thus, the latter variant can be particularly advantageous in which variant the same at least one optical sensor which detects the image angle of at least 90° in the operating position of the hand held instrument is configured to detect the monitoring area according to the preceding description. This way the single optical sensor can perform the task of associating different substrates and detecting the marking drawn by the pen tip. Compared to the possible solution described supra of using two different optical sensors a single sensor of this type would be technically more complex because its focal range and detection or monitoring area would have to be adaptable as a function of the respective application which could be achieved by actuators in the lens arrangement or by an aspherical multifocal lens.

As a matter of principle the hand held instrument according to the invention is independent from a manner how the captured data is processed and/or forwarded. A hand held instrument is advantageous which includes a data memory which facilitates storing at least the data which is detected by the at least one optical sensor. A hand held instrument of this type is in the first place usable completely independently from a separate data processing system. Transmitting the data to a data processing system of this type can be performed at any later point in time for example using a data cable.

Wireless data transmission using a transmitter unit, however, is particularly advantageous. Thus it is also conceivable to transmit information captured by the sensor directly, this means immediately to an external device using the transmitter unit or to transmit the data stored on a data storage device. In any case it is only required for the functionality of the hand held instrument that the at least one optical sensor (optionally also additional sensors optical or non optical) captures the data reliably. A software processing of the data which eventually renders the marking that is generated by the hand held instrument reproducible can be easily preformed independently from data capturing at a later point in time, for example using a data processing system in combination with hand writing recognition software.

It is also conceivable that the hand held instrument itself includes a computation unit, for example configured as a micro processer which can be used for at least partially processing captured data or only for compressing the data for reducing memory space requirements.

In order to better differentiate whether the hand held instrument is in its operating position or not, it is particularly advantageous when the hand held instrument includes a pressure sensor at the pen tip, wherein a touch-down of the pen tip on the substrate is detectable by the pressure sensor. As soon as the pressure sensor detects a touch-down pressure of the pen tip the hand held instrument is in its operating position. Furthermore the pressure sensor facilitates detecting the respective operating characteristics. In case of using the hand held instrument configured as a writing instrument for example a high contact pressure of the pen tip can indicate a for example comparatively high line thickness. Furthermore a pressure signal of the pressure sensor can be use for activating or deactivating an optical sensor that is being used for detecting the drawn marking. A situation dependent activation and deactivation of a sensor of this type is useful in particular with respect to a possible operating time using an optionally provided energy storage device.

Furthermore a hand held instrument is particular advantageous which includes an additional tool at an end oriented away from the pen tip wherein the additional tool is configured for example for deleting the marking drawn by the pen tip. In case the hand held instrument configured as a writing instrument has a pencil lead the tool can be configured for example as an eraser. In a particularly advantageous embodiment the tool arranged at the end is configured for operating capacitive touch screens. A replicable tool is particularly advantageous in this respect.

In another advantageous embodiment according to the invention the hand held instrument has at least one pressure switch which is advantageously arranged in a shaft of the hand held instrument and wherein the pressure switch can be activated by pressing on an outer enveloping surface of the shaft. Advantageously the pressure switch is arranged in a gripping portion of the hand held instrument where a user holds the hand held instrument. Thus, the pressure switch is essentially arranged in a portion between the thumb and the pointer finger of the user. A pressure switch of this type could be used for example in a hand held instrument configured as a writing instrument for virtually switching between different writing modes (writing, marking) or different colors. Information regarding actuation of the pressure switch can either be processed directly according to the methods described supra or it can be stored in a preliminary manner on a data storage device.

The technical object is achieved by a method according to the invention in that the at least one optical sensor detects an image angle of at least 90°, advantageously at least 100°, further advantageously at least 110°. Detecting the image angle using plural optical sensors as described supra is thus also feasible.

The method according to the invention can thus be performed in a particularly simple manner using the hand held instrument according to the invention. The method is particularly well suited for identifying substrates which are processed by the hand held instrument without requiring a special substrate. Using a substrate and transferring the hand held instrument from a substrate to a second substrate is therefore preformed without a preceding release, e.g. by detecting a particular code. Furthermore the method is particularly well suited to detect where on the respective substrate processing by the hand held instrument is preformed and how different substrates are positioned relative to each other. The reason is that detecting the described image angle already detects a rather large portion of the respective substrate even when the optical sensor has rather low height.

According to a particularly advantageous embodiment of the invention it is advantageous when at least one edge of the substrate, advantageously two opposite edges of the substrate are detected by the at least one optical sensor in an identification position of the hand held instrument in which the pen tip has a distance from the substrate. This is particularly advantageous because detecting the edges provides an orientation aid which facilitates in a simple manner to detect where on the respective substrate processing with the hand held instrument is performed.

With respect to identifying the respective substrate or also the location where writing is currently performed it is particularly helpful when at least a portion of a surrounding area of the substrate is detected in the identification position of the hand held instrument by the at least one optical sensor. In particular in case a substrate has not been written on or has been written on very little the detection and processing of the surrounding area is particularly suited for the intended identification. Thus, it has become apparent that identifying the respective substrate works particularly well in an identification position of the hand held instrument in which the pen tip is arranged at a distance measured perpendicular to substrate which is at the most one third of the narrow side of the substrate when the identification area which is covered by the optical sensor covers at least the narrow side of the substrate and advantageously a portion of the surrounding area. For a DIN A4 sheet this means that a distance of the tip from the substrate is approximately 7 cm and the detected width is greater than 21 cm. This would correspond to an image angle of at least 112°. An image angle of identical size is required so that a sensor in a pen supported outside of the sheet center at a distance of approximately 5 cm in a non orthogonal position still detects both edges of a narrow side of an A4 substrate. The method is particularly advantageous when using the following steps:

a) Data captured by the at least one optical sensor is transmitted by a transmitter unit and/or a data transmission cable to an external data processing system.

b) The transmitted data is processed by a data processing system and the marking originally generated by the hand held instrument is reconstructed, wherein information captured by the at least one optical sensor regarding different substrates that are being used is processed.

According to this method the hand held instrument with its sensors is solely used for capturing the data while the processing is only performed at a later point in time. This way it is not necessary to configure the hand held instrument with a proprietary independent computation unit, however this is quite feasible.

Furthermore it can be quite advantageous when the data captured by the at least one optical sensor is stored by a data memory integrated in the hand held instrument. This way the hand held instrument is useable anytime and anywhere and it is independent from the surrounding infrastructure, for example in a wireless network.

A method of this type can also be particularly advantageous in which the at least one optical sensor of the hand held instrument is used in an operating position of the hand held instrument in which the pen tip is in contact with the substrate to detect the marking generated by the pen tip.

Eventually an advantageous embodiment of the invention provides a set including a hand held instrument of the type recited supra and a data processing system wherein the data processing system includes means for processing data detected in the surrounding area of the substrate.

### BRIEF DESCRIPTION OF THE DRAWINGS

The invention described supra is subsequently described in more detail based on two embodiments with reference to drawing figures wherein:

FIG. 1 illustrates a first hand held instrument according to the invention configured as a writing instrument during a switch from a first substrate to a second substrate.

FIG. 2 illustrates a schematic of the hand held instrument according to the invention; and

FIG. 3 illustrates another hand held instrument according to the invention with two sensors.

### DETAILED DESCRIPTION OF THE INVENTION

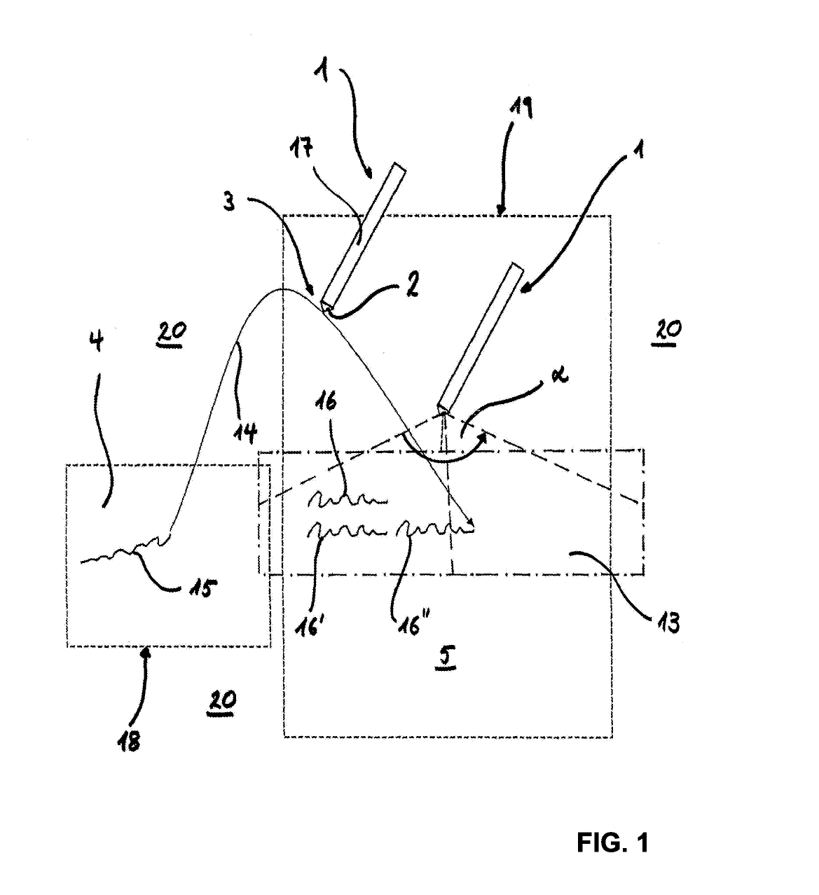

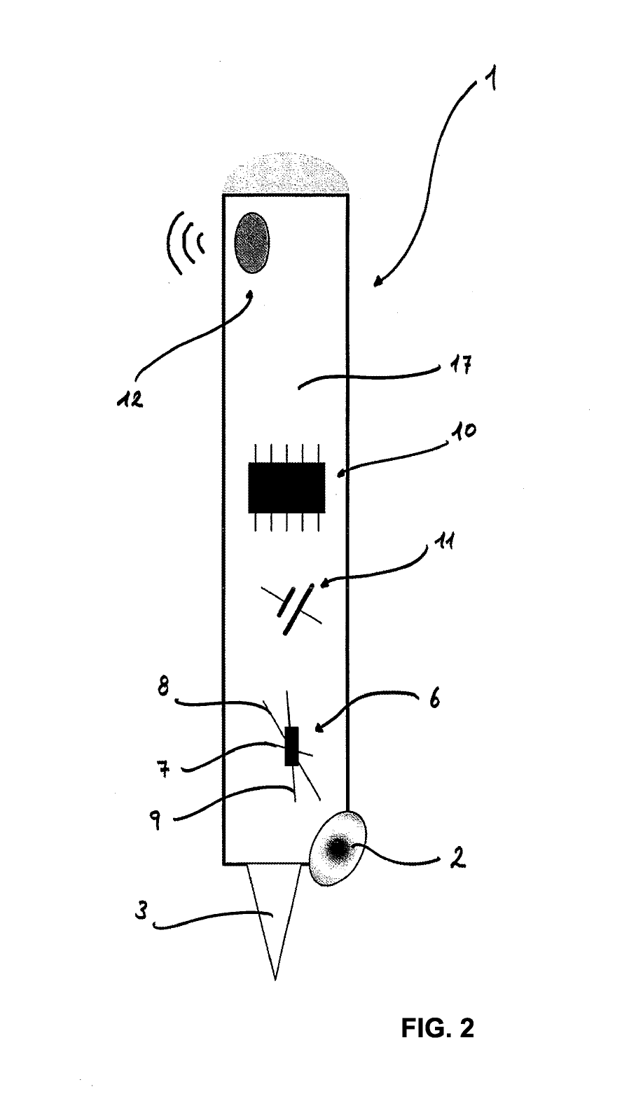

In a first embodiment of the hand held instrument 1 configured as a writing instrument which is illustrated in FIGS. 1 and 2 the hand held instrument 1 includes an optical sensor 2 which is arranged proximal to a pen tip 3 at an end of the hand held instrument 1 that is oriented towards a substrate 4, 5. Furthermore the hand held instrument 1 includes three acceleration sensors 7, 8, 9 that are combined in a sensor unit 6 arranged at a shaft 17 of the hand held instrument, wherein the acceleration sensors are used for detection an acceleration of the hand held instrument 1 in a three dimensional space. The acceleration sensors 7, 8, 9 and a data memory 10 are provided with electrical energy from an energy storage device 11. A transmitter unit 12 is arranged at an end of the hand held instrument 1 which is oriented away from the pen tip 3, wherein data detected by the optical sensor 2 and by the acceleration sensors 7, 8, 9 can be transmitted to an external receiver. Thus, it is also feasible to transmit the data detected by the sensors 2, 7, 8, 9 directly, this means without intermediary storage in the data memory 10 or to save the captured data initially in the data memory 10 and to transmit it only thereafter using the transmission unit 12.

The writing instrument 1 illustrated herein only includes one optical sensor 2 which detects a (horizontal) image angle α of 110°, wherein the Illustrated image angle α forms a crown angle of the image angle provided according to the invention, wherein the image angle is formed between idealized light beams starting from a center point of a refraction plane of optics of the optical sensor 2 and edges of its image surface. Consequently the image angle according to claim 1 is identical to the image angle α illustrated in FIG. 1 which as described supra forms the associated crown angle.

Due to the image angle α according the invention the optical sensor 2 having a side ratio of image width to image height of 4 to 3 is configured in a detection position of the hand held instrument 1 in which the pen tip 3 is arranged at a distance of approximately 10 cm from the substrate which is measured orthogonal to the respective substrate 4, 5 to detect a detection area 13 with a surface of 600 cm².

Furthermore the image angle α according to the invention of sensor 2 facilitates a detection of lateral edges 18, 19 of the substrates 4, 5 and of a surrounding area 20 arranged outside of the substrates 4, 5, since already for a rather small height of the optical sensor 2 above the respective substrate 4, 5 the image angle α according to the invention has the consequence that a width of the detection portion 13 is equal to or greater than a width of the respective substrate 4, 5. This is particularly advantageous for the functionality of the hand held instrument 1 with respect to its detection power and association of a generated marking with a particular substrate 4, 5. The size of the detection area 13 of over 600 cm² is particularly useful since the optical sensor 2 captures a large amount of image information which can be used in order to facilitate a unique association of the hand held instrument 1 with one of the substrates 4, 5 that are being used. Detecting the edges 18, 19 of the substrates 4, 5 and detecting the surrounding area 20 is helpful in this respect. A special type of substrate as was required according to the prior art in order to perform an association of a writing instrument with a substrate. This is not required any longer for the hand held instrument 1 according to the invention. Instead all types of substrates are equally feasible.

FIG. 1 illustrates a switch of the hand held instrument 1 from a smaller substrate 4 to a larger substrate 5. At the point in time when the pen tip 3 of the hand held instrument 1 leaves the substrate 4 and is moved along the three dimensional curve is illustrated by the arrow 14 the acceleration sensors 7, 8, 9 detect acceleration values which indicate that the hand held instrument 1 is not used for generating a marking 15 on the substrate 4 any longer, but that it was lifted off from the substrate 4. This change of the acceleration characteristics of the hand held instrument 1 has the consequence that the optical sensor 2 switches into an identification mode for identifying the substrate to be processed next. The optical sensor 2 now continuously captures data which is to be used identifying the substrate to be used next.

It is now illustrated in FIG. 1 how the optical sensor 2 covers an area with a width of over 21 cm and detects the markings 16, 16′, 16″ that are already provided on the substrate 5 and edges 19 of the substrate 5 and surrounding area 20. Information thus derived can be subsequently used in an evaluation process performed by a data processing system in order to unambiguously determine that the subsequent recording must have been performed on the substrate 5. Furthermore it can be reconstructed based on the information at which location on the substrate 5 the hand held instrument 1 is arranged. Continuously monitoring the substrate 5 with the optical sensor 2 and advantageously continuously detecting the travelled path of the hand held instrument 1 using the acceleration sensors 7, 8, 9 eventually facilitates determining an exact touch-down point of the hand held instrument 1, wherein the optical sensor 2 can also be continuously active.

It is therefore particularly advantageous that the hand held instrument 1 according to the invention is configured to independently detect hand recordings true to the original. Using a special paper or similar is not necessary.

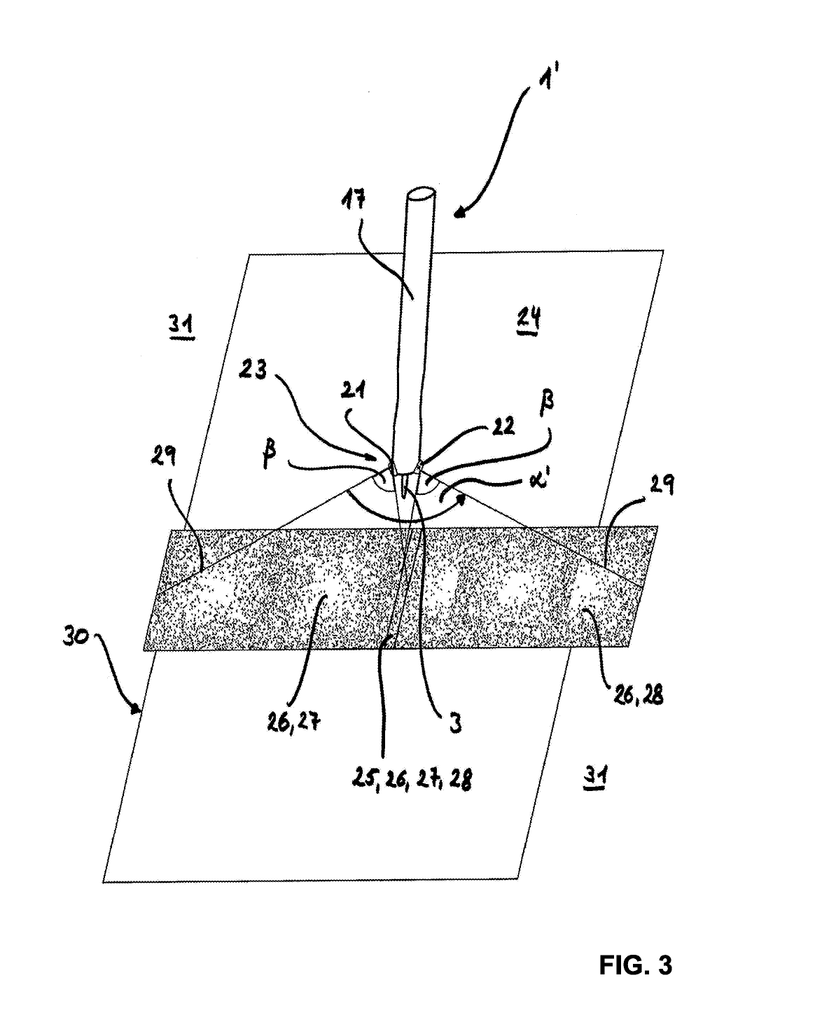

Another embodiment that is illustrated in FIG. 3 shows another hand held instrument 1′ according to the invention which includes two optical sensors 21, 22 which is different from the hand held instrument 1 described supra. These optical sensors 21, 22 jointly detect an image angle α′ of 100°, wherein each of the two optical sensors 21, 22 by themselves has an image angle configured as a partial image angle β of 55°. As evident from FIG. 3 the sensors 21, 22 are arranged on opposite sides of the shaft 17 of the hand held instrument 1′ wherein both sensors 21, 22 are arranged in an end section 23 of the hand held instrument 1′ which end section is oriented towards the pen tip 3.

The hand held instrument 1′ is configured as a writing instrument which is used in the illustrated case to write on an illustrated substrate 24. The hand held instrument 1′ is arranged at an elevation of approximately 6 cm above the substrate 24 which elevation is measured orthogonal to the substrate 24 wherein the substrate is a sheet of DIN A5 paper.

FIG. 3 illustrates that idealized light beams 29 of the two optical sensors 21, 22 respectively extend at a partial image angle β of 55° starting from optics of the sensors 21, 22 in a direction towards the substrate 24. The light beams 29 respectively define a portion on the substrate 24 of a common identification area 26 which is illustrated in dotted lines. In an overlap area 25 which is arranged approximately under the pen tip 3 of the hand held instrument 1 individual partial detection areas 27, 28 of the two optical sensors 21, 22 overlap so that a common image angle α′ of 100° is effectively detected.

The hand held instrument 1′ is in a position above the substrate 24 so that lateral edges 30 of the substrate 24 form a portion of the identification area 26. Additionally the hand held instrument 1′ detects a portion of the surrounding area 31 of the substrate 24. Overall the hand held instrument 1′ facilitates unambiguously identifying the substrate 24 and to unambiguously associate a marking generated by the hand held instrument 1′ with the substrate 24 during subsequent processing.

### REFERENCE NUMERALS AND DESIGNATIONS

1, 1′ hand held instrument
2 optical sensor
3 pen tip
4 substrate
5 substrate
6 sensor unit
7 acceleration sensor
8 acceleration sensor
9 acceleration sensor
10 data storage device
11 energy storage device
12 transmission unit
13 identification area
14 three dimensional curve
15 marking
16, 16′, 16″ marking
17 shaft
18 edge
19 edge
20 surrounding area
21 optical sensor
22 optical sensor
23 end section
24 substrate
25 overlap area
26 identification area
27 partial identification area
28 partial identification area
29 light beam
30 edge
31 surrounding area
α, α′ Image angle
β partial image angle

What is claimed is:

1. A method for associating a pen shaped hand held instrument with a substrate or for detecting a switching of the substrate,
wherein the pen shaped hand held instrument includes at least one pen tip which generates a marking, a shaft, and at least one optical sensor which detects at least a coarse pattern from an identification position in which the pen tip has a distance from the substrate,
the method comprising the steps:
detecting at least the coarse pattern with the at least one optical sensor at least in an identification area which includes a portion of the substrate and at least a lateral edge of the substrate or at least a portion of a surrounding area of the substrate which surrounding area is directly adjacent to all edges of the substrate; and
associating the pen shaped hand held instrument with the substrate or detecting a switching of the substrate.

2. The method according to claim 1, further comprising the step:
detecting an image angle of at least 90 with the at least one optical sensor.

3. The method according to claim 2, further comprising the step:
detecting the image angle with at least two optical sensors, wherein each individual optical sensor detects a partial image angle of the image angle.

4. The method according to claim 1, further comprising the steps:
transmitting data captured by the at least one optical sensor through a transmission unit or a data transmission cable to an external data processing system; and
processing transmitted data with the external data processing system and reconstructing the at least one marking originally generated by the hand held instrument,
wherein information is considered that is detected by the at least one optical sensor regarding different substrates that are being used.

5. The method according to claim 1, further comprising the steps:
storing data that is captured by the at least one optical sensor, wherein the data is stored in a data memory integrated in the hand held instrument; and
at least partially processing or compressing the data captured by the at least one optical sensor in a computing unit integrated in the hand held instrument.

6. The method according to claim 1, further comprising the steps:
continuously using the at least one optical sensor or an additional optical sensor or at least three acceleration sensors which are respectively arranged perpendicular to one another and which continuously detect an acceleration in three dimensions of at least a portion of the hand held instrument in an operating position of the hand held instrument in which the pen tip is in contact with the substrate to detect the marking generated by the pen tip.

7. A pen shaped hand held instrument for processing a substrate, comprising:
at least one pen tip;
a shaft;
at least one optical sensor; and
at least three acceleration sensors
wherein the pen tip is in contact with the substrate in an operating position of the hand held hand held instrument,
wherein the at least one optical sensor is arranged proximal to the pen tip at an end of the hand held instrument that is oriented towards the substrate,
wherein the optical sensor has an image angle of at least 90,
wherein at least an identification portion which includes a portion of the substrate and at least a lateral edge of the substrate or at least a portion of a surrounding area of the substrate which is directly adjacent to all edges of the substrate is detectable from an identification position in which the pen tip has a distance from the substrate,
wherein the at least three acceleration sensors are respectively arranged perpendicular to each other and continuously detect an acceleration of at least a portion of the hand held instrument in a three dimensional space.

8. The hand held instrument according to claim 7, wherein an analysis of data of the acceleration values captured by the acceleration sensors is performed regarding differences of types of motions, including an operating movement of the hand held instrument and a movement of the hand held instrument in the three dimensional space which facilitates activating an identification function which identifies the substrate.

9. The hand held instrument according to claim 7, wherein data of the acceleration values captured by the acceleration sensors facilitate detecting a touch-down of the pen tip on the substrate.

10. The hand held instrument according to claim 7, further comprising a pressure sensor that is arranged at the pen tip, wherein the pressure sensor facilitates detecting a touch-down of the pen tip on the substrate

11. A pen shaped hand held instrument for processing a substrate, comprising:
at least one pen tip;
a shaft;
at least one optical sensor; and
at least three acceleration sensors
wherein the pen tip is in contact with the substrate in an operating position of the hand held hand held instrument,
wherein the at least one optical sensor is arranged proximal to the pen tip at an end of the hand held instrument that is oriented towards the substrate,
wherein the optical sensor has an image angle of at least 90°,
wherein at least an identification portion which includes a portion of the substrate and at least a lateral edge of the substrate and at least a portion of a surrounding area of the substrate which is directly adjacent to all edges of the substrate is detectable from an identification position in which the pen tip has a distance from the substrate,
wherein the at least three acceleration sensors are respectively arranged perpendicular to each other and continuously detect an acceleration of at least a portion of the hand held instrument in a three dimensional space.

12. The method according to claim 1, further comprising the steps:
continuously using the at least one optical sensor and an additional optical sensor and at least three acceleration sensors which are respectively arranged perpendicular to one another and which continuously detect an acceleration in three dimensions of at least a portion of the hand held instrument in an operating position of the hand held instrument in which the pen tip is in contact with the substrate to detect the marking generated by the pen tip.
